(19) United States
(12) Patent Application Publication
(10) Pub. No.: US 2015/0302204 A1
(43) Pub. Date: Oct. 22, 2015

(54) METHOD AND APPARATUS FOR DISPLAYING TEST RESULT OF TERMINAL

(71) Applicant: TENCENT TECHNOLOGY (SHENZHEN) COMPANY LIMITED, Shenzhen, Guangdong (CN)

(72) Inventors: Xucheng Wan, Shenzhen (CN); Yanhui Shen, Shenzhen (CN)

(21) Appl. No.: 14/443,987

(22) PCT Filed: Jul. 31, 2013
(86) PCT No.: PCT/CN2013/080531

§ 371 Date: May 19, 2015

(30) Foreign Application Priority Data
Nov. 20, 2012 (CN) 201210469978.3

(51) Int. Cl. G06F 21/57

(52) U.S. Cl. CPC G06F 21/577; G06F 2221/034

(57) ABSTRACT

The present disclosure provides a method and an apparatus for displaying a test result of a terminal. The method includes: obtaining a last test value and a last test time of the terminal, the test value reflecting a system health condition of the terminal; determining a time span between a current time and the last test time; updating the last test value according to the time span to obtain a current test value; and displaying the current test value. By means of the present disclosure, the test value of the terminal can be updated over time; in this way, the test value can reflect the health condition of the system more accurately, and therefore the performance and security coefficients of the computer system can be improved by performing system optimization according to the test value.

### RELATED APPLICATION

This application is the U.S. National Phase application of International Application No. PCT/CN2013/080531, filed Jul. 31, 2013, and claims priority to Chinese Patent Application No. 201210469978.3, filed with the Chinese Patent Office on Nov. 20, 2012 and entitled “TERMINAL TESTING METHOD AND APPARATUS”, the disclosures of both of which are incorporated herein by reference in their entirety.

### FIELD OF THE TECHNOLOGY

The subject matter disclosed by the present disclosure relates to the field of computer processing, and in particular, to a method and apparatus for displaying a terminal test result.

### BACKGROUND OF THE DISCLOSURE

In the existing technology, to ensure the operational security of a computer, a computer checkup may be performed to obtain a health score. Security management software installed in the computer checks the computer quickly and thoroughly for risks, and after the computer checkup is complete, the result of checkup is provided in the form a health score to indicate the status of the computer.

Determining factors of the health score of the computer generally include “security protection status of the computer” and “to-be-optimized system items of the computer”. Detection of the security protection status includes whether network access security protection is enabled, whether application portal protection is enabled, and whether system bottom protection is enabled. Detection of the to-be-optimized system items includes system trash, system vulnerabilities, startup items, and other items related to system security and performance Items to be repaired and optimized in the computer can be detected through the checkup, and a current health score of the computer can be obtained through weighting calculation by using a particular mechanism.

However, at present, the health score generally is a score obtained after the computer is optimized according to the checkup result, which causes that the health score is usually quite high and does not change over time; and the score will remain at the previous high score state unless the user starts another checkup. Because nowadays most computers connect to the Internet and the user operates the computer frequently, the health state changes greatly over time, and as a result, the health score cannot reflect the current real health condition of the computer of the user.

### SUMMARY

In view of this, according to one aspect, the present disclosure provides a method for displaying a test result of a terminal, including:

obtaining a last test value and a last test time of the terminal, the test value reflecting a system health condition of the terminal;

determining a time span between a current time and the last test time;

updating the last test value according to the time span to obtain a current test value; and

displaying the current test value,

in which the updating the last test value according to the time span to obtain a current test value comprises obtaining the current test value according to the following formulae:

f(x)=m (x≦t1),

f(x)=m−x−t1 (t1<x≦m−t2)

f(x)=t3 (m−t2<x)

where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

The displaying the current test value includes:

displaying a current health score form, where the current health score form includes a current monitoring value, a score funnel and a changing tendency arrow, and the score funnel and the changing tendency arrow are used for identifying an accumulative effect of the time span on the current test value.

The terminal is a computer, and the system health condition includes a security protection status of the computer and/or to-be-optimized system items of the computer.

According to another aspect, an embodiment of the present invention further provides an apparatus for displaying a test result of a terminal, including:

memory;

one or more processors; and

one or more programs stored in the memory and configured for execution by the one or more processors, the one or more programs comprising the following instruction units:

an information acquiring unit, configured to obtain a last test value and a last test time of the terminal, the test value reflecting a system health condition of the terminal;

a time determining unit, configured to determine a time span between a current time and the last test time;

an updating unit, configured to update the last test value according to the time span to obtain a current test value; and

a displaying unit, configured to display the current test value,

in which the updating unit is configured to obtain the current test value according to the following formulae:

f(x)=m (x≦t1),

f(x)=m−x−t1 (t1<x≦m−t2)

f(x)=t3 (m−t2<x)

where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

The displaying unit is configured to display a current health score form, where the current health score form includes a current monitoring value, a score funnel and a changing tendency arrow, and the score funnel and the changing tendency arrow are used for identifying an accumulative effect of the time span on the current test value.

According to still another aspect, an embodiment of the present invention further provides a computer storage medium, including a program stored therein, the program being executed to:

obtain a last test value and a last test time of a terminal, the test value reflecting a system health condition of the terminal;

determine a time span between a current time and the last test time;

update the last test value according to the time span to obtain a current test value; and

display the current test value,

in which when the program is executed to update the last test value according to the time span to obtain a current test value, the program is executed to obtain the current test value according to the following formulae:

f(x)=m (x≦t1),

f(x)=m−x−t1 (t1<x≦m−t2)

f(x)=t3 (m−t2<x)

where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

When the program is executed to display the current test value, the program is executed to:

display a current health score form, wherein the current health score form comprises a current monitoring value, a score funnel and a changing tendency arrow, and the score funnel and the changing tendency arrow are used for identifying an accumulative effect of the time span on the current test value.

The terminal is a computer, and the system health condition comprises a security protection status of the computer and/or to-be-optimized system items of the computer.

The embodiments of the present invention has the following beneficial effects:

In the embodiments of the present invention, when the test value is displayed, a time interval between the last test time and the current time is taken into consideration, and the test value is updated according to the time interval, so that the displayed test value can reflect the effect of the test time interval. Moreover, specifically, the longer the time interval is, the lower the displayed test value is, and the current real health condition of the system can be better reflected. In this way, the test value can reflect the health condition of the system more accurately, and therefore the performance and security coefficients of the computer system can be improved by performing system optimization according to the test value.

### BRIEF DESCRIPTION OF THE DRAWINGS

To describe the technical solutions of the embodiments of the present invention or the existing technology more clearly, the following briefly introduces the accompanying drawings required for describing the embodiments or the existing technology. Apparently, the accompanying drawings in the following description show only some embodiments of the present invention, and a person of ordinary skill in the art may still derive other drawings from these accompanying drawings without creative efforts.

FIG. 1 is a specific schematic flowchart of a method for displaying a test result of a terminal according to an embodiment of the present invention;

FIG. 2 is another specific schematic flowchart of a method for displaying a test result of a terminal according to an embodiment of the present invention;

FIG. 3 is a specific schematic diagram illustrating the change of a health score state according to an embodiment of the present invention;

FIG. 4 is a specific schematic diagram of a health score state according to an embodiment of the present invention; and

FIG. 5 is a specific schematic structural diagram of an apparatus for displaying a test result of a terminal according to an embodiment of the present invention.

### DESCRIPTION OF EMBODIMENTS

The following describes in detail the embodiments of the present invention with reference to the accompanying drawings in the embodiments of the present invention. Apparently, the described embodiments are merely some of the embodiments of the present invention rather than all of the embodiments. All other embodiments obtained by a person of ordinary skill in the art based on the embodiments of the present invention without creative efforts shall fall within the protection scope of the present disclosure.

Real-timeliness of a health score of a computer checkup in the existing technology is poor, and the health score cannot be updated unless a new checkup process is started through a checkup function portal. Such a health score lacks the effect of a time dimension, and cannot reflect the actual health condition of the computer. Accordingly, the embodiments of the present invention provide a method for displaying a test result of a terminal, which takes the effect of a time interval into consideration when the health score is displayed, which increases the dimensions of the health score without the need to actually run the checkup program again, so that the system burden is not increased.

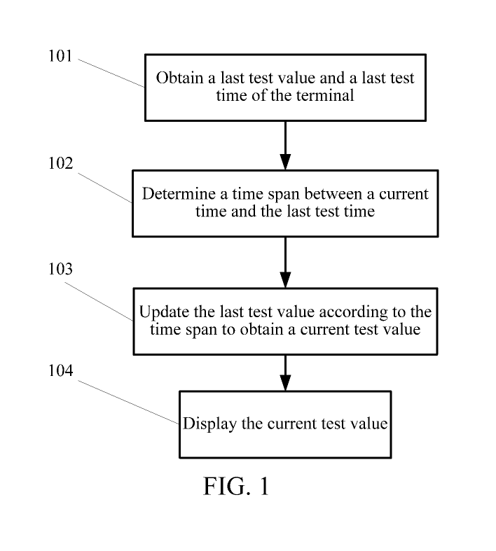

FIG. 1 is a specific schematic flowchart of a method for displaying a test result of a terminal according to an embodiment of the present invention. The method includes the following steps:

101: Obtain a last test value and a last test time of the terminal, the test value reflecting a system health condition of the terminal.

By way of example, the terminal is a computer, and the system health condition may include a security protection status of the computer and/or to-be-optimized system items of the computer. Generally, after every health test, an event record is generated at system background, so as to form a checkup timestamp.

102: Determine a time span between a current time and the last test time. By using the above specific condition as an example, the time span since a last checkup can be determined by using the timestamp and the current system time.

103: Update the last test value according to the time span to obtain a current test value.

Specifically, it is determined whether the time span is less than or equal to a predefined time threshold, and it is determined that the current inspecting value is equal to the previous inspecting value if a determining result is yes; or the current test value that is less than the last test value is obtained according to the time span if a judging result is no.

More specifically, the current test value may be obtained according to the following formulae:

f(x)=m (x≦t1),

f(x)=m−x−t1 (t1<x≦m−t2)

f(x)=t3 (m−t2<x)

where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

Values of t1, t2 and t3 may be set appropriately according to an actual condition.

104: Display the current test value. For example, a current health score form may be displayed, where the current health score form includes a current monitoring value, a score funnel and a changing tendency arrow, and the score funnel and the changing tendency arrow are used for identifying an accumulative effect of the time span on the current test value.

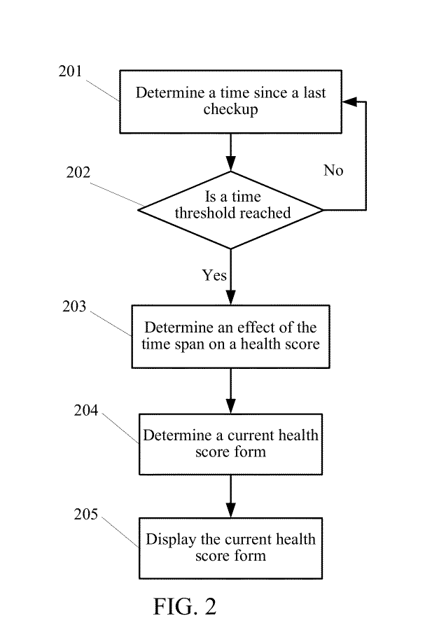

The embodiments of the present invention are further described below by using a health score of a computer checkup as an example. As shown in FIG. 2, an embodiment of the present invention provides a method for displaying a health score. The method includes the following steps:

201: Determine a time since a last checkup. Each time a user performs a health checkup, a time record is generated at system background, so as to form a checkup timestamp, where the timestamp is used for determining a time span since the last checkup.

202: Determine whether the time span reaches a time threshold. That is, a time threshold is set in advance, the time span that reflects a time interval between the checkup timestamp and a current time is obtained according to the checkup timestamp and the current time, and when the time span does not exceed the time threshold, it is considered that the time span has no effect on the health score of the computer, and return to step 201. When the time span exceeds the time threshold, it is considered that the time span has an effect on the health score of the computer, and perform step 203. Setting of the time threshold is related to factors such as the value range of the health score, for example, when the value of the health score ranges from 0 to 100, a default value of the threshold may be set to 5 (days) in order to ensure adaptability of the time threshold.

203: Determine an effect of the time span on the health score. After it is determined in steps 201 to 202 that the time span reaches the time threshold, a function relation between the time span x and the health score is determined, where m is a last health score.

The function specifically is:

f(x)=m (x≦5),

f(x)=m−x−5 (5<x≦m−15)

f(x)=20 (m−15<x)

In this specific embodiment, the time threshold is 5 (days); the constants in the above formulae are 15 and 20, which are only examples, and the constants may also be specifically set to other values.

204: Determine a current health score form.

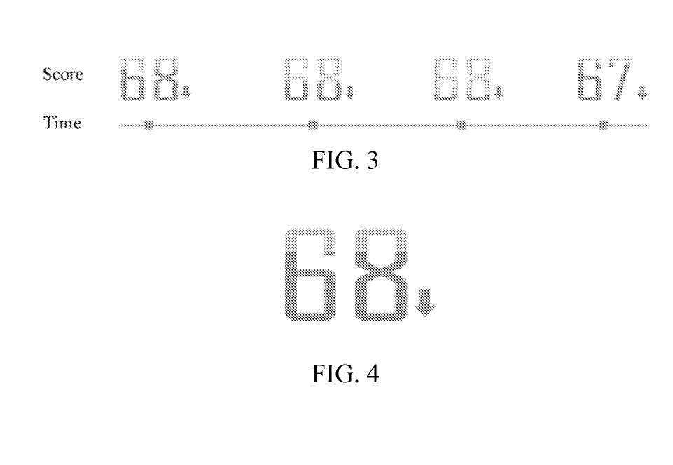

It can be known from the foregoing description of steps that the health score remains unchanged before the time threshold is reached. After the time threshold is reached, the score gradually decreases as the number of days increases, and the change in score is transient. Therefore, in this embodiment, an accumulative effect of time on the health score is vividly shown by using a funnel form, an arrow and the like, and in this way, the transient change can be expressed in a form that is visible for a long time. A color block height of the funnel gradually decreases over time; as shown in FIG. 3, the color block of the funnel refers to that a number is divided into displayed parts of different grey scales. It can be seen from FIG. 3 that, in four numbers arranged from left to right, proportions of grey parts of different color depths in the whole number change, where the larger the proportion of light grey is, the closer the health score is to a critical point of change. Each time the color block height decreases to 0, the score decreases by 1 point, and then the funnel recovers to the full state.

The current health score form is determined according to the time span, the time threshold, the current health score and the foregoing rules. That is, the number in the form, proportions of black and white blocks in the number (certainly, to obtain a beautiful display effect, colored block may be used for displaying, or other icons may be added beside the number for prompting; there may be multiple specific displaying solutions, and the details are not further described herein), and a changing tendency are determined.

205: Display the current health score form. As shown in FIG. 4, the current health score form consists of three parts: 1. a current health score, 2. a score funnel, and 3. an arrow indicating the tendency to increase or decrease. In this embodiment, the displayed current health score is 68, and has a tendency to decrease.

It can be seen that time is used as a factor that affects the health score in this embodiment, and the effect of time on the health score is presented by using a particular function relation, so that the real-time health score is obtained.

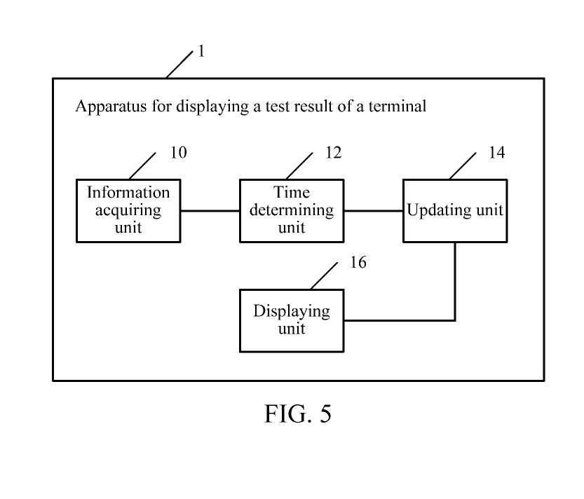

FIG. 5 is a specific schematic structural diagram of an apparatus for displaying a test result of a terminal according to an embodiment of the present invention. The apparatus may be disposed in a computer, or may be disposed in a mobile phone or other mobile terminals.

For example, the apparatus may be an application that is installed in the computer, and runs when the computer is started or when a predetermined time is reached or a predetermined event occurs. The apparatus 1 includes: an information acquiring unit 10, configured to obtain a last test value and a last test time of the terminal, the test value reflecting a system health condition of the terminal; a time determining unit 12, configured to determine a time span between a current time and the last test time; an updating unit 14, configured to update the last test value according to the time span to obtain a current test value; and a displaying unit 16, configured to display the current test value. The system health condition may include a security protection status of the computer and/or to-be-optimized system items of the computer.

The updating unit 14 may be configured to determine whether the time span is less than or equal to a predefined time threshold, and determine that the current test value is equal to the last test value if a determining result is yes; or obtain the current test value that is less than the last test value according to the time span if a determining result is no.

Further, the updating unit 14 may be configured to obtain the current test value according to the following formulae:

f(x)=m (x≦t1),

f(x)=m−x−t1 (t1<x≦m−t2)

f(x)=t3 (m−t2<x)

where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2. For example, it may be predetermined that t1 is 5 (days), t2 is 15, t3 is 20.

The displaying unit 16 may be configured to display a current health score form, where the current health score form includes a current monitoring value, a score funnel and a changing tendency arrow, and the score funnel and the changing tendency arrow are used for identifying an accumulative effect of the time span on the current test value. For example, current health score form is displayed as a form in FIG. 4.

It should be understood that the terms and the functions of the units/modules in the foregoing apparatus embodiment are consistent with those in the foregoing method embodiment, and the details are not described herein again.

In conclusion, in the embodiments of the present invention, when the test value is displayed, a time interval between the last test time and the current time is taken into consideration, and the test value is updated according to the time interval, so that the displayed test value can reflect the effect of the test time interval.

Moreover, specifically, the longer the time interval is, the lower the displayed test value is, and the current real health condition of the system can be better reflected.

A person of ordinary skill in the art may understand that all or some of the steps in the methods according to the foregoing embodiments may be implemented by a computer program instructing relevant hardware. For example, the information acquiring unit 10, the time determining unit 12, the updating unit 14 and the displaying unit 16 in FIG. 5 are stored in a storage medium of the apparatus 1 for displaying a test result of a terminal, and are executed by at least one processor in the apparatus 1 for displaying a test result of a terminal, so as to implement the methods for displaying a test result of a terminal that are shown in FIG. 1 and FIG. 2.

The content disclosed above is merely a preferred embodiment of the present invention, and is definitely not intended to limit the claimed scope of the present disclosure. Therefore any equivalent change made according to the claims of the present disclosure should still fall within the scope of the present disclosure.

1. A method for displaying a test result of a terminal, comprising:
obtaining a last test value and a last test time of the terminal, the test value reflecting a system health condition of the terminal;
determining a time span between a current time and the last test time;
updating the last test value according to the time span to obtain a current test value; and
displaying the current test value,
wherein the updating the last test value according to the time span to obtain a current test value comprises obtaining the current test value according to the following formulae:
f(x)=m (x≦t1),
f(x)=m−x−t1 (t1<x≦m−t2)
f(x)=t3 (m−t2<x)
where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

2. (canceled)

3. (canceled)

4. The method according to claim 1, wherein the displaying the current test value comprises:
displaying a current health score form, wherein the current health score form comprises a current monitoring value, a score funnel and a changing tendency arrow, and the score funnel and the changing tendency arrow are used for identifying an accumulative effect of the time span on the current test value.

5. The method according to claim 2, wherein the terminal is a computer, and the system health condition comprises a security protection status of the computer and/or to-be-optimized system items of the computer.

6. An apparatus for displaying a test result of a terminal, comprising:
memory;
one or more processors; and
one or more programs stored in the memory and configured for execution by the one or more processors, the one or more programs comprising the following instruction units:
an information acquiring unit, configured to obtain a last test value and a last test time of the terminal, the test value reflecting a system health condition of the terminal;
a time determining unit, configured to determine a time span between a current time and the last test time;
an updating unit, configured to update the last test value according to the time span to obtain a current test value; and
a displaying unit, configured to display the current test value,
wherein the updating unit is configured to obtain the current test value according to the following formulae:
f(x)=m (x≦t1),
f(x)=m−x−t1 (t1<x≦m−t2)
f(x)=t3 (m−t2<x)
where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

7. (canceled)

8. (canceled)

9. The apparatus according to claim 4, wherein the displaying unit is configured to display a current health score form, wherein the current health score form comprises a current monitoring value, a score funnel and a changing tendency arrow, and the score funnel and the changing tendency arrow are used for identifying an accumulative effect of the time span on the current test value.

10. (canceled)

11. A computer storage medium, comprising a program stored therein, the program being executed to:
obtain a last test value and a last test time of a terminal, the test value reflecting a system health condition of the terminal;
determine a time span between a current time and the last test time;
update the last test value according to the time span to obtain a current test value; and
display the current test value,
wherein when the program is executed to update the last test value according to the time span to obtain a current test value, the program is executed to obtain the current test value according to the following formulae:
f(x)=m (x≦t1),
f(x)=m−x−t1 (t1<x≦m−t2)
f(x)=t3 (m−t2<x)
where f(x) represents the current test value, x represents the time span, m represents the last test value, t1 represents the predefined time threshold, t2 represents a predefined first constant threshold, t3 represents a predefined second constant threshold, t1<t2<m−t1, and t3<m−t1−t2.

12. The computer storage medium according to claim 11, wherein when the program is executed to display the current test value, the program is executed to:
display a current health score form, wherein the current health score form comprises a current monitoring value, a score funnel and a changing tendency arrow, and the score funnel and the changing tendency arrow are used for identifying an accumulative effect of the time span on the current test value.

13. The computer storage medium according to claim 12, wherein the terminal is a computer, and the system health condition comprises a security protection status of the computer and/or to-be-optimized system items of the computer.
